(19) United States
(12) Patent Application Publication
(10) Pub. No.: US 2015/0070430 A1
(43) Pub. Date: Mar. 12, 2015

(54) METHOD FOR OPERATING AN INKJET DEVICE

(71) Applicant: OCE-TECHNOLOGIES B.V., Venlo (NL)

(72) Inventors: Paul KUIPER, Eindhoven (NL); Hendrik J. STOLK, Bergen (NL); Robert P. FAESSEN, Best (NL)

(73) Assignee: OCE-TECHNOLOGIES B.V., Venlo (NL)

(21) Appl. No.: 14/543,446

(22) Filed: Nov. 17, 2014

Related U.S. Application Data
(63) Continuation of application No. PCT/EP2013/059995, filed on May 15, 2013.

(30) Foreign Application Priority Data
Jun. 1, 2012 (EP) 12170381.3

(51) Int. Cl. B41J 2/045

(52) U.S. Cl. CPC B41J 2/04551; B41J 2/04581
USPC 347/14

(57) ABSTRACT

The invention relates to a method for operating an inkjet device, the inkjet device comprising a piezo-electric element. The inkjet device may be configured to operate in a plurality of modes, the plurality of modes comprising a first mode, wherein the inkjet device is in an off state; a second mode, wherein the inkjet device is in a standby state; and a third mode, wherein the inkjet device is in an operative state. Depending on the state of the inkjet device, the BIAS voltage applied to the piezo-electric element is selected.

The present invention relates to a method for operating an inkjet device, said inkjet device comprising a piezoelectric actuator comprising a piezo-electric element, wherein a BIAS voltage is applied over the piezo-electric element.

### BACKGROUND OF THE INVENTION

In inkjet printing, it is known to use piezo-electric actuators comprising a piezo-electric element. The piezo-electric elements may flex upon applying an electric pulse and may thereby generate a pressure pulse in an actuation chamber which may lead to the ejection of a droplet of ink through a nozzle. The piezo-electric element is generally a layer of a piezo-electric material, provided with a bottom electrode and an upper electrode. The piezo-electro material is polarized, such that the domains in the piezo-electric material become aligned. The polarized piezo-electric material may deform when an electric pulse is applied to the material.

Polarization may be permanent, but in some cases, the piezo-electric material may depolarize in time. For example, thin layers of piezo-electric material may depolarize in time. It is known to prevent depolarization of piezo-electric element by applying a so-called BIAS voltage to the piezo-electric element. When the BIAS voltage is applied to the piezo-electric element, the piezo-electric element may be kept in a polarized state. However, permanent application of the BIAS voltage may lead to degradation of the piezo-electric material. For example, conductive paths may be formed in the piezo-electric material. When the piezo-electric element, comprising the piezo-electric material is provided with electrodes on a bottom surface and a top surface, the creation of conductive paths in the piezo-electric material may generate a short circuit in the piezo-electric actuator, thereby rendering the piezo-electric actuator inoperative.

It is therefore an object of the invention to mitigate the above-mentioned problem. It is a further object of the invention to improve the lifetime of a piezo-electric actuator.

### SUMMARY OF THE INVENTION

The object is achieved in a method for operating an inkjet device, said inkjet device comprising a piezoelectric actuator comprising a piezo-electric element, the method comprising a first mode, wherein the inkjet device is in an off state, a second mode, wherein the inkjet device is in a standby state and a third mode of the inkjet device, wherein the inkjet device is in an operative state, and wherein the method comprises the steps of:
a. in the first mode, applying no BIAS voltage over the piezo-electric element;
b. in the second mode, applying a first BIAS voltage over the piezo-electric element;
c. in the third mode, applying a second BIAS voltage over the piezo-electric element, wherein the second BIAS voltage is higher than the first BIAS voltage.

In inkjet printing an image may be build up drop wise by applying droplets of ink onto a receiving medium. The droplets may be applied onto the receiving medium by an inkjet device. The inkjet device may be e.g. a inkjet print head. The inkjet print head may be positioned in an inkjet printing apparatus. The inkjet printing apparatus may comprise one print head or a plurality of print heads.

The inkjet device, such as the print head, may comprise a piezoelectric actuator.

Preferably, the ink jet device may comprise a plurality of piezoelectric actuators. The piezoelectric actuator comprises a piezoelectric element. The piezoelectric element is an element that may deform upon applying a voltage over the element. For example, when the piezoelectric element is a relatively thin sheet or disc comprising piezoelectric material, the sheet or disc may flex upon application of an electrical pulse over the sheet, or disc. In order for the piezoelectric element to be efficiently operated, electric dipoles present in the piezoelectric element may need to be aligned. The alignment of the dipoles is also known as poling. Upon application of a poling operation, the piezoelectric element may become poled. However, the piezoelectric element may not be permanently poled; the polarization may decrease with time. When polarization decreases, the extent of deformation of the piezoelectric element upon application of a certain voltage may decrease. In an piezoelectric actuator for expelling fluids, the pressure build up in a piezoelectric actuator, that may lead to expelling a droplet of a fluid through an orifice, may therefore decrease with time upon gradual depolarization of the piezoelectric element. This may cause less efficient expel of droplets, or even no expel of droplets at all. In order to keep the piezo-electric element polarized, a BIAS voltage may be applied over the piezoelectric element. A BIAS voltage may be applied over the piezo-electric element by applying a voltage to an upper electrode and/or a lower electrode of the piezo-electric element. The BIAS voltage may preferably be a direct (i.e. non-alternating) voltage. The BIAS voltage may provide an electrical field, due to which the dipoles present in the piezo-electric element may align and remain aligned. The BIAS voltage is not configured to eject droplets of ink through a nozzle.

The BIAS voltage may be applied to the piezoelectric element independently from actuation pulses, said actuation pulses being configured to flex the piezo-electric element thereby ejecting a droplet of ink through a nozzle. Actuation pulses are also known in the art as drive pulses. Preferably, the BIAS voltage and the actuation pulses may both be applied to the piezoelectric element via the upper and the lower electrode connected to the piezoelectric element. In that case, the actuation pulses may be superimposed on the BIAS voltage.

When the BIAS voltage is not applied to the piezo-electric element, the polarization of the piezoelectric element may decrease with time. When the BIAS voltage is re-applied to the piezo-electric element, the piezo-electric element may be re-polarized. Re-polarization may not be instantaneous, but may take a certain period of time. The application of the BIAS voltage may however, result in the formation of conductive paths in the piezoelectric element. The formation of conductive paths may result in degradation of the piezo-electric element. For example, in case electrodes are provided at different surfaces of the piezoelectric element, e.g. at a bottom surface and an upper surface, then the electrodes may be short-circuited upon the formation of the conductive paths in the piezoelectric element. In that case, the piezoelectric element may not function anymore.

The inkjet device may be operated in a plurality of modes. For example, in a first mode, the inkjet device may be in an off state. In the off state, the inkjet device may be inoperative. For example, the inkjet device may be switched off, e.g. the inkjet printing apparatus may be switched off. Alternatively, the inkjet printing apparatus may comprise a plurality of inkjet devices, such as print heads. A first part of the plurality of print heads may be in printing operation. However, optionally, a second part of the plurality of print heads may not be in printing operation, but may be switched off. For example, if the inkjet printing apparatus is a color inkjet printing apparatus, comprising a black ink, a yellow ink, a magenta ink and a cyan ink, each ink being applied by a separate print head, only the print head adapted to apply black ink onto the receiving medium may be in printing operation when printing a black-and white image. When printing the black and white image, the print heads dedicated to apply ink having a color different than black, such as yellow, magenta or cyan ink, may be switched off and may be inoperative. In case the inkjet device, such as the print head is in the off state, no ink droplets may be expelled by the piezoelectric actuator. Therefore, the piezoelectric actuator may not actuate. Therefore, it may not be necessary that the piezoelectric element is polarized when the inkjet device is in the first mode. Thus, the BIAS voltage may not need to be applied when the inkjet device is in the first mode. Please note that the fact that no BIAS voltage may be applied over the piezo-electric actuator does not necessarily mean that there is no electrical potential difference over the piezo-electric actuator. The piezo-electric element may function as a capacitor. If the piezoelectric element acts as a capacitor, the difference in potential over the piezo-electric element may not disappear instantaneously, when the BIAS voltage is switched off. When no BIAS voltage is applied, no voltage may be applied to the electrodes attached to the piezo-electric element. Alternatively, a voltage may be applied to an upper electrode of the piezo-electric element having the same voltage applied to a lower electrode of the piezo-electric element. In both cases, there may be no net electric potential difference applied over the piezo-electric element.

In the second mode, the inkjet device may be in a standby state. In the standby state, the inkjet device, such as the print head, the inkjet device may be in a state wherein the inkjet device is not in an operative state, but the inkjet device is not switched off, either. For example, the inkjet device, such as a print head, may not be in printing operation. In the second mode, the inkjet device may be e.g. in between print jobs. When an inkjet device is not in actual printing operation, but is expected to turn into printing operation soon—e.g. because a next printing job is expected soon—, the inkjet device may be brought in a standby state. In the standby state, some functions of the inkjet device, e.g. heating, circulation of the ink, spitting of ink droplets, may be switched off, whereas other functions of the inkjet device may not be switched off. In the standby state, the inkjet device may not have to expel droplets.

In the standby state, a first BIAS voltage may be applied. The first BIAS voltage may not be zero. However, the first BIAS voltage may be a relatively low voltage. By applying a relatively low BIAS voltage to the piezo-electric element, the piezo-electric element may loose some of its polarization with time. Therefore, the piezo-electric element may not be fully polarized anymore. As a consequence, the flexing of the piezo-electric element upon application of an actuation pulse to the piezo-electric element may decrease.

However, the piezo-electric element may not become fully depolarized when the first BIAS voltage is applied. It may be acceptable to loose some of the polarization of the piezo-electric element, when the inkjet device is not in printing operation. When the inkjet device may need to turn into printing operation again, a larger BIAS voltage may be applied, thereby restoring the polarization of the piezo-electric element to its desired value. An advantage of the temporary lowering of the BIAS voltage is that the rate of degradation of the piezo-electric element may be decreased, which may result in a longer lifetime of the piezo-electric element. A longer lifetime of the piezo-electric element may also increase the lifetime of the inkjet device. Moreover, less energy is needed when a lower BIAS voltage is applied.

The first BIAS voltage may be applied to the piezo-electric element, e.g. by applying a first voltage to one of the upper and lower electrode attached to the piezo-electric element and grounding the other one of the upper and lower electrode attached to the piezo-electric element.

In the third mode, the inkjet device may be in an operative state. For example, the inkjet device may be a print head, such as an inkjet print head. In the operative state of the inkjet print head, the inkjet print head may be printing. For example, the piezo-electric actuators, comprising the piezo-electric elements, may be actuating. This may be done by applying an actuation pulse to the piezo-electric element, the piezo-electric element thereby flexing. The actuation pulse may be applied to the piezo-electric element via electrodes connected to the piezo-electric element. The flexing of the piezo-electric element may result in the decrease of the volume of an ink pressure chamber, such that a pressure pulse is generated in ink present in the pressure chamber. The pressure pulse may result in a droplet of ink being expelled from the inkjet print head via an orifice of the print head.

In order to efficiently expel droplets, the flexing of the piezo-electric element upon the application of an actuation pulse should be sufficient to generate a pressure wave in the fluid in the pressure chamber that may lead to the expel of a droplet of ink through an orifice. The flexing of the piezo-electric element upon application of a pressure pulse depends e.g. on the polarization of the piezo-electric element. Inkjet device is in an operative state, e.g. when a print head is expelling droplets, the polarization of the piezo-electric elements should thus preferably be at a sufficient high level. Therefore, in the third mode of the inkjet device, a second BIAS voltage is applied, the second BIAS voltage being higher than the first BIAS voltage. The second BIAS voltage may preferably be sufficiently high to keep the piezo-electric actuator at the desired level of polarization. The BIAS voltage may be applied to the piezo-electric element via electrodes, for example the electrodes also used to apply an actuation pulse to the piezo-electric element.

In an embodiment, a ramp up of the BIAS voltage is applied to increase the BIAS voltage from the first BIAS voltage to the second BIAS voltage upon going from the second mode to the third mode.

In the second mode of the inkjet device, a first BIAS voltage may be applied to the piezo-electric element. In the third mode of the inkjet device, a second BIAS voltage may be applied to the piezo-electric element. The second BIAS voltage may be higher than the first BIAS voltage. Herein, when referring to a higher BIAS voltage, the higher BIAS voltage is a voltage that has a higher absolute value. The absolute value of the voltage refers to the distance between the BIAS voltage and 0 V. For example, if the BIAS voltage is a positive voltage, the higher BIAS voltage (the second BIAS voltage) has a higher (positive) voltage than the lower BIAS voltage (first BIAS voltage). If, on the other hand, the BIAS voltage is a negative voltage, then the higher BIAS voltage (second BIAS voltage) is a more negative voltage than the lower BIAS voltage (first BIAS voltage).

When the inkjet device goes from the second mode to the third mode, the BIAS voltage may need to increase from the first BIAS voltage to the second BIAS voltage, the second BIAS voltage being higher than the first BIAS voltage. The increase of the BIAS voltage may be effected by a ramp up of the BIAS voltage. In addition, when the inkjet device goes from the first mode to the second mode, or from the first mode to the third mode, a ramp up of the BIAS voltage may be applied as well to increase the BIAS voltage that is applied over the piezo-electric element.

In an embodiment, a ramp down of the BIAS voltage is applied to decrease the BIAS voltage from the second BIAS voltage to the first BIAS voltage upon going from the third mode to the second mode. When the inkjet device goes from the third mode to the second mode, the BIAS voltage may need to decrease from the second BIAS voltage to the first BIAS voltage, the first BIAS voltage being lower than the second BIAS voltage. The decrease of the BIAS voltage may be effected by a ramp down of the BIAS voltage. In addition, when the inkjet device goes from the third mode to the first mode, or from the second mode to the first mode, a ramp down of the BIAS voltage may be applied as well to switch off the BIAS voltage that is applied over the piezo-electric element.

In an embodiment, the piezo-electric element has an upper surface and a bottom surface, the upper surface and the bottom surface each being provided with an electrode for actuating the piezo-electric element, wherein a distance between the upper surface of the piezo-electric element and the bottom surface of the piezo-electric element is in the range of 0.5 μm-15 μm.

In the method according to the present invention, the BIAS voltage applied over the piezo-electric element may be varied. The BIAS voltage may be applied by electrodes, that are operatively connected to the piezo-electric element. For example, the electrodes may be positioned on surfaces of the piezo-electric actuator, such as an upper surface of the piezo-electric element and a bottom surface of the piezo-electric element. If the electrodes are attached directly to the piezo-electric element and the electrodes are attached to opposite surfaces of the piezo-electric element, the distance between the two electrodes may correspond to the thickness of the piezo-electric material. It may be advantageous to use a thin layer of piezo-electric material. Piezo-electric material may be relatively expensive, thus it is preferred not to use too much of this material. A thin layer of piezo-electric material may have a thickness in the range of 0.5 μm-15 μm, preferably in the range of 1.0 μm-10 μm, more preferably from 2.0 μm-8 μm, such as from 3.0 μm-5 μm. A thin layer of piezo-electric material may loose polarization in the course of time and may therefore not be polarized permanently.

To keep the piezo-electric element polarized, a BIAS voltage may be applied. However, permanently applying a BIAS voltage to piezo-electric element may lead to degradation of the piezo-electric element. Therefore, by applying the method according to the present invention, the piezo-electric element may be sufficiently polarized when droplets of a fluid have to be expelled, while decreasing the rate of degradation of the piezo-electric element.

In an embodiment, wherein the inkjet device is operatively coupled to a control unit, the control unit being adapted to receive image data to be printed, the control unit being further adapted to generate print data from the image data and to control the inkjet device to expel droplets in accordance with the print data by driving the piezoelectric actuators, wherein the method comprises the steps of:
1. in operation of the inkjet device, determining a future period of inactivity of the piezoelectric actuator based on the print data;
2. comparing the determined period of inactivity with a predetermined period of time (δt),

wherein, if the determined period of inactivity is larger than the predetermined period of time (at), the method further comprises the step of:
3. at the start of the period of inactivity, applying the ramp down of the BIAS voltage to decrease the BIAS voltage from the second BIAS voltage to the first BIAS voltage thereby bringing the inkjet device in the second mode.

The inkjet device may be operatively coupled to a control unit. For example, the inkjet device and the control unit may both form part of a printing device, such as an inkjet printer. The control unit may also be operatively connected to external sources, for example to receive data. The control unit may be adapted to receive image data to be printed. For example, the control unit may be adapted to receive image data to be printed via a computer network or via a USB port. The control unit may further process the image data. For example, the control unit may be further adapted to generate print data from the image data. In addition, the control unit may be adapted to control the inkjet device to expel droplets in accordance with the print data by driving the piezo-electric actuators. The print data generated by the control unit may comprise the data based on which the piezo-actuators are driven. In addition, the print data generated by the control unit may comprise data based on which the piezo-electric actuators are to be driven in the (near) future. For example, when an inkjet device starts printing a print job, the control unit may already have generated the data for the complete print job, and thereby may have generated data based on which the piezo-electric actuator are driven in the (near) future. From the print data, in a first step, the control unit may deduct whether an inkjet device may experience a period of inactivity in the (near) future or not.

The control unit may determine a future period of inactivity in operation of the inkjet device, e.g. when the printing device is in printing operation. In a second step, the determined future period of inactivity may be compared to a predetermined period of in time (at). If the determined period of inactivity is larger than the predetermined period of time (at), then the ramp down of the BIAS voltage to decrease the BIAS voltage from the second BIAS voltage to the first BIAS voltage may be applied at the start of the period of inactivity, thereby bringing the inkjet device in the second mode.

When lowering the BIAS voltage, the piezo-electric element may depolarize to some extend. When the piezo-electric element has to become operative again, it may take some time to re-polarize the piezo-electric element. Therefore, the benefits of lowering the BIAS voltage from the second BIAS voltage to the first BIAS voltage—e.g. increase of life time of the piezo-electric actuator—may have to be weighted against the extra time that may possibly be needed to re-polarize the piezo-electric actuator. Thus, the BIAS voltage may only be lowered if the envisaged period of inactivity exceeds a predetermined period of time (δt). If the envisaged period of inactivity does not exceed the predetermined period of time (δt), then the inkjet device may be kept in the third state and the second BIAS voltage may be maintained.

In an embodiment, the predetermined period of time (δt) may be at least the amount of time needed to re-polarize the piezo-electric element. When the predetermined period of time (δt) is larger than the amount of time needed to re-polarize the piezo-electric element, the piezo-electric element may be fully polarized when the inkjet device is brought in the third mode. When the piezo-electric element is fully polarized, the inkjet device may be able to efficient expel droplets of a fluid.

In an embodiment, the inkjet device is configured for jetting droplets of an ink composition at an elevated temperature, wherein in the second and third mode, the piezo-electric actuator is controlled to be at the elevated temperature.

Properties of the ink, such as density and viscosity may be temperature dependent. The optimal temperature for jetting such ink compositions may therefore depend on the type of ink. Thus, inks may be jetted at elevated temperature. Elevated temperature may be a temperature in the range of 40° C.-150° C., such as a temperature in the range of 50° C.-130° C. Inks that may be preferably jetted at elevated temperature may be hot melt ink compositions, or radiation curable ink compositions, such as UV curable ink compositions. UV curable inks may preferably be jetted at a temperature in the range of 30° C.-90° C., such as from 40° C.-70° C., for example from 50° C.-60° C. UV curable inks may be jetted at an elevated temperature, e.g. a temperature above room temperature, because of their low viscosity at elevated temperatures, which is beneficial for the jetting process. On the other hand, UV curable inks may preferably not be jetted at too high temperatures, because the temperature may induce curing, which may be unwanted if the ink is not yet jetted. UV curable inks may be e.g. solvent based UV curable inks or may be essentially solvent-free.

Optionally, UV curable ink may comprise a thickener, such as a gelling agent. Those type of ink compositions are also known as UV gelling inks. UV gelling inks may form a gelled phase below a certain temperature. In the gelled phase, the viscosity may be higher than in the non-gelled (liquid) phase. Therefore, UV gelling inks are typically jetted at a temperature wherein the ink is in the non-gelled (liquid) phase. UV curable inks may be jetted at a temperature within the range of 35° C.-100° C., for example in the range of 45° C.-85° C., such as from 55° C.-75° C.

When the ink is at elevated temperature, the inkjet device comprising the piezo-electric actuator may also be at elevated temperature. The inkjet device may be at the elevated temperature when the inkjet device is jetting and is thus in the third mode. Moreover, the inkjet device may be at elevated temperature when the inkjet device is in the standby state. In the standby state, the inkjet device may preferably be configured to be able to be brought in the third mode quickly. Thus, it is preferred that in the second state, the inkjet device is at elevated temperature, because otherwise, the inkjet device may have to be heated first, before reaching the active state, which may take some time. At elevated temperature, degradation of the piezo-electric element may take place faster than at room temperature. Thus, the life time of an inkjet device, configured for jetting droplets of a hot melt composition may be increased by temporarily decreasing the BIAS voltage, when the inkjet device is in the standby state and when the inkjet device is in an off state. On the other hand, depolarization may take place faster than at room temperature. Therefore, by applying the higher BIAS voltage when the inkjet device is in the operative state, the piezo-electric element may be sufficiently polarized to efficiently expel droplets in the operative state and thus, droplets of ink may be efficiently expelled by the inkjet device.

In a further embodiment, the ink composition is a hot melt composition, the hot melt composition being a composition that is solid at room temperature and liquid at an elevated temperature, wherein in the second and third mode, the piezo-electric actuator is controlled to be at the elevated temperature.

A known type of inkjet ink is hot melt ink. A hot melt composition may be solid at room temperature and liquid at an elevated temperature. For example, the hot melt ink composition may melt at a temperature in the range of 40° C.-150° C., such as from 60° C.-130° C., for example from 80° C.-110° C. Since the hot melt composition is solid, instead of liquid at room temperature, jetting of the ink preferably takes place at the elevated temperature, where the hot melt ink composition is a fluid.

In an embodiment, a method for operating a printing device is provided, the printing device comprising a control unit, a first inkjet device and a second inkjet device, the control unit being configured to operate each of the inkjet devices in accordance with claim 1 independently.

A printing device, such as an inkjet printing apparatus may comprise a plurality of inkjet devices, such as print heads. When the printing device is in operation, not necessarily all inkjet devices of the printing device need to be in operation; some inkjet devices may be in an operative state, whereas other inkjet devices may not be in an operative state.

The printing device may further comprise a control unit. The control unit may control the operation of the printing device. The control unit may also control the operation of the subunits of the printing device independently. Subunits of the printing device may be a paper input module, a paper output module, a fuser, etc. Also an inkjet print head may be a subunit of the printing device. A printing device may comprise a plurality of inkjet devices, such as print heads. The inkjet devices, such as the print heads, may be operated independently. Thus, the control unit may control the operation of each one of the inkjet devices independently. For example, if the printing apparatus is a color printing apparatus, being configured to be able to print images using differently colored inks, for example Cyan, Magenta, Yellow and black ink, the printing apparatus may print full color. The printing device may comprise one inkjet device, configured to expel droplets of one of the plurality of differently colored inks. For example, the printing device may comprise a first inkjet device dedicated to print in black. In case a monochrome black image is to be printed, the control unit may control the first inkjet device to be in an operative state. As a consequence, a second BIAS voltage may be applied over the piezo-electric elements in the inkjet device, such as the print head, in the operative state. When printing a monochrome black images, the second inkjet device, e.g. an inkjet device configured to eject magenta, cyan or yellow ink, may be controlled to be in a standby state or in an off state. Depending on the state of the inkjet devices, a first BIAS voltage or no BIAS voltage may be applied over the piezo-electric elements in the second inkjet device.

In an embodiment, the first inkjet device and the second inkjet device are integrated in one print head. In printing devices applying inkjet devices, usually images are printed in scanning inkjet or in single pass inkjet using a page wide inkjet device. In single pass inkjet, wherein a page-wide print head is used, the print head may only move with respect to the receiving medium in the direction of paper feed-through. The print head and the receiving medium may not move in a direction perpendicular to the direction of paper feed-through. The print head may comprise a plurality of drop forming units, each drop forming unit comprising a piezo-electric actuator comprising a piezo-electric element. Each drop forming unit within the print head may be controlled independently.

The print head may comprise e.g. a first inkjet device and a second inkjet device, wherein the first inkjet device is a first droplet forming unit and the second inkjet device is a second droplet forming unit. If the print head and the receiving medium have about the same width, wherein width may be defined as the distance between two opposite edges determined in a direction perpendicular to the direction of paper feed-through, then the first droplet forming unit may be positioned in the middle of the print head, with respect to the direction perpendicular to the direction of paper feed-through, and the second droplet forming unit may be positioned in a side edge of the print head. If an image is to be applied to the image receiving medium by the print head, wherein the side edges of the image receiving medium do not need to be printed, but the middle of the image receiving medium has to be printed, then the first inkjet device may be in an operative state, whereas the second inkjet device may not be in an operative state. As a consequence, a second BIAS voltage may be applied over the piezo-electric elements in the first inkjet device, in the operative state. Depending on the state of the second inkjet device, a first BIAS voltage or no BIAS voltage may be applied over the piezo-electric elements in the second inkjet device.

In an embodiment, multiple print heads are integrated in one inkjet device. The inkjet device may be an assembly of print heads. A printing device may comprise a plurality of print head assemblies.

As described above, a printing device, being a color printing apparatus, configured to print images using different colors of ink, may comprise a plurality of inkjet devices, each of the inkjet devices configured to print a specific color, such as red, blue, green, orange, purple or yellow. The inkjet device may comprise a plurality of print heads. For example, if a high printing speed is desired and/or large surfaces need to be printed, it may be advantageous to use an assembly of print heads, comprising a plurality of print heads, instead of a single print head, per color of ink to be applied.

In case a monochrome image is to be printed, the control unit may control the first inkjet device configured to eject the desired color of ink to be in an operative state. As a consequence, a second BIAS voltage may be applied over the piezo-electric elements in the print head in the operative state. When printing the monochrome image, the second inkjet device, being configured to eject a different color of ink, may be controlled to be in a standby state or in an off state. Depending on the state of the inkjet devices, a first BIAS voltage or no BIAS voltage may be applied over the piezo-electric elements in the second inkjet devices.

### BRIEF DESCRIPTION OF THE DRAWINGS

FIG. 1A shows a schematic representation of an image forming apparatus.

FIG. 1B shows an ink jet printing assembly

FIG. 2A illustrates a first embodiment of the method according to the present invention.

FIG. 2B illustrates a second embodiment of the method according to the present invention.

FIG. 3 shows a flow diagram of a method according to an embodiment of the present invention.

### Detailed description of the drawings

In the drawings, same reference numerals refer to same elements.

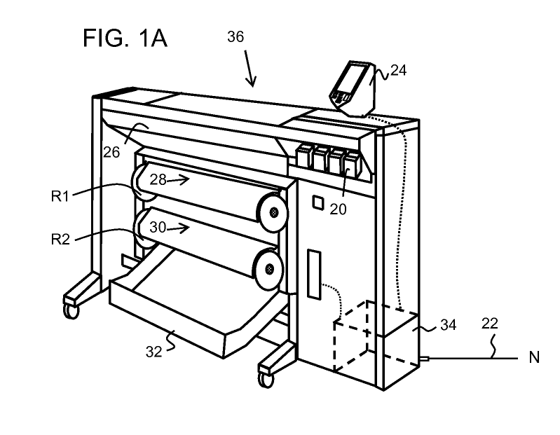

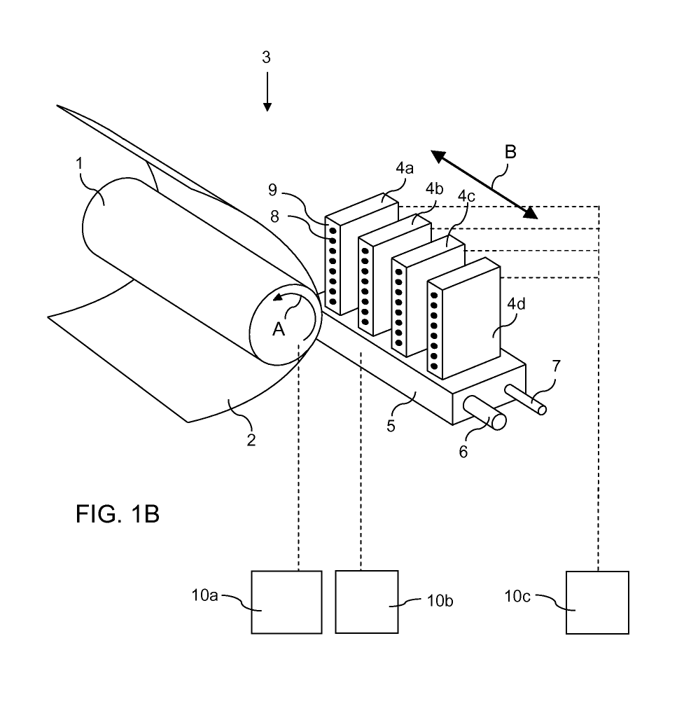

FIG. 1A shows an image forming apparatus 36, wherein printing is achieved using a wide format inkjet printer. The wide-format image forming apparatus 36 comprises a housing 26, wherein the printing assembly, for example the ink jet printing assembly shown in FIG. 1B is placed. The image forming apparatus 36 also comprises a storage means for storing image receiving member 28, 30, a delivery station to collect the image receiving member 28, 30 after printing and storage means for marking material 20. In FIG. 1A, the delivery station is embodied as a delivery tray 32. Optionally, the delivery station may comprise processing means for processing the image receiving member 28, 30 after printing, e.g. a folder or a puncher. The wide-format image forming apparatus 36 furthermore comprises means for receiving print jobs and optionally means for manipulating print jobs. These means may include a user interface unit 24 and/or a control unit 34, for example a computer.

Images are printed on an image receiving member, for example paper, supplied by a roll 28, 30. The roll 28 is supported on the roll support R1, while the roll 30 is supported on the roll support R2. Alternatively, cut sheet image receiving members may be used instead of rolls 28, 30 of image receiving member. Printed sheets of the image receiving member, cut off from the roll 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the printing apparatus 36. The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be sent to the printer via this USB port.

FIG. 1B shows an ink jet printing assembly 3. The ink jet printing assembly 3 comprises supporting means for supporting an image receiving member 2. The supporting means are shown in FIG. 1B as a platen 1, but alternatively, the supporting means may be a flat surface. The platen 1, as depicted in FIG. 1B, is a rotatable drum, which is rotatable about its axis as indicated by arrow A. The supporting means may be optionally provided with suction holes for holding the image receiving member in a fixed position with respect to the supporting means. The ink jet printing assembly 3 comprises print heads 4a-4d, mounted on a scanning print carriage 5. The scanning print carriage 5 is guided by suitable guiding means 6, 7 to move in reciprocation in the main scanning direction B. Each print head 4a-4d comprises an orifice surface 9, which orifice surface 9 is provided with at least one orifice 8. The print heads 4a-4d are configured to eject droplets of marking material onto the image receiving member 2. The platen 1, the carriage 5 and the print heads 4a-4d are controlled by suitable controlling means 10a, 10b and 10c, respectively.

The image receiving member 2 may be a medium in web or in sheet form and may be composed of e.g. paper, cardboard, label stock, coated paper, plastic or textile.

Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the invention. In practice an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a - 4d, containing a differently colored marking material.

The carriage 5 is guided by guiding means 6, 7. These guiding means 6, 7 may be rods as depicted in FIG. 1B. The rods may be driven by suitable driving means (not shown). Alternatively, the carriage 5 may be guided by other guiding means, such as an arm being able to move the carriage 5. Another alternative is to move the image receiving material 2 in the main scanning direction B.

Each print head 4a-4d comprises an orifice surface 9 having at least one orifice 8, in fluid communication with a pressure chamber containing fluid marking material provided in the print head 4a-4d. On the orifice surface 9, a number of orifices 8 is arranged in a single linear array parallel to the sub-scanning direction A. Eight orifices 8 per print head 4a-4d are depicted in FIG. 1B, however obviously in a practical embodiment several hundreds of orifices 8 may be provided per print head 4a-4d, optionally arranged in multiple arrays. As depicted in FIG. 1B, the respective print heads 4a-4d are placed parallel to each other such that corresponding orifices 8 of the respective print heads 4a-4d are positioned in-line in the main scanning direction B. This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 8.

Upon ejection of the marking material, some marking material may be spilled and stay on the orifice surface 9 of the print head 4a-4d. The ink present on the orifice surface 9, may negatively influence the ejection of droplets and the placement of these droplets on the image receiving member 2. Therefore, it may be advantageous to remove excess of ink from the orifice surface 9. The excess of ink may be removed for example by wiping with a wiper and/or by application of a suitable anti-wetting property of the surface, e.g. provided by a coating.

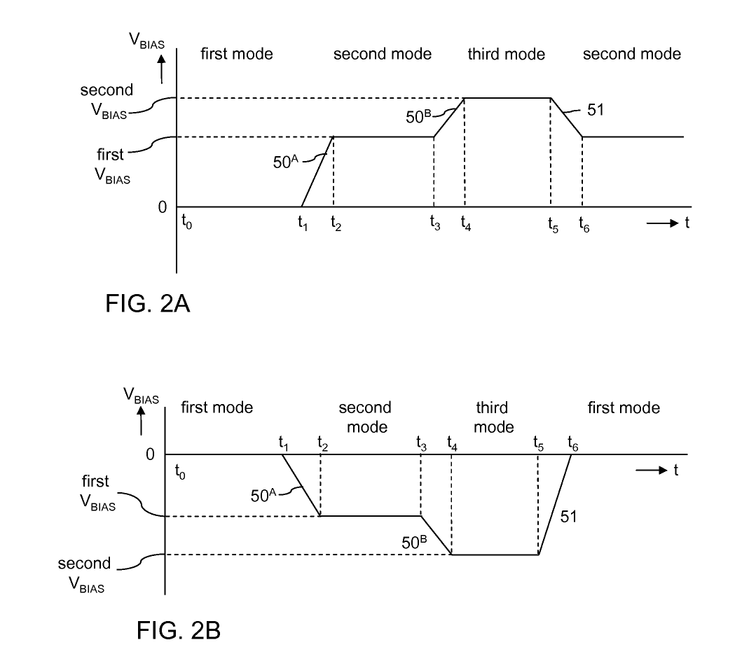

FIG. 2A and 2B illustrate embodiments of the method according to the present invention.

In FIG. 2A, the level of the BIAS voltage V_{BIAS} at the different modes of the inkjet device is shown. The inkjet device may be operated in at least three different modes; a first mode, a second mode and a third mode. Depending on the state of the inkjet device, a certain BIAS voltage V_{BIAS} is applied to over the piezo-electric element.

In FIG. 2A, the mode of the inkjet device changes in the course of time. At t₀, the inkjet device is first in the first mode. In the first mode of the inkjet device no BIAS voltage V_{BIAS} is applied over the piezo-electric element. Because there is no BIAS voltage V_{BIAS} applied, there is no BIAS voltage V_{BIAS} over the piezo-electric element, as is shown in FIG. 2A. Please note that if the piezo-electric element would act as a capacity, then there may be some electric field over the piezo-electric element, even if no BIAS voltage V_{BIAS} is actively applied. The inkjet device is in the first mode until t₁. At t₁, a RAMP UP 50^{A} of the BIAS voltage V_{BIAS} is applied. As a consequence, at t₂, the BIAS voltage V_{BIAS} is at the level of the first BIAS voltage. The inkjet device is now in the second mode. The inkjet device stays in the second mode from t₂ to t₃. During this period, the first BIAS voltage V_{BIAS} is applied over the piezo-electric actuator. At t₃, a second RAMP UP 50^{B} of the BIAS voltage V_{BIAS} is applied, thereby increasing the BIAS voltage V_{BIAS} from the first BIAS voltage to the second BIAS voltage. The inkjet device is now in the third mode. The inkjet device stays in the third mode from t₄ to t₅. During this period, the second BIAS voltage V_{BIAS} is applied over the piezo-electric actuator. At t₅, a RAMP DOWN 51 of the BIAS voltage V_{BIAS} is applied, thereby decreasing the BIAS voltage V_{BIAS} from the second BIAS voltage to the first BIAS voltage. At t₆, the inkjet device is in the second mode again.

In FIG. 2B, like in FIG. 2B, the level of the BIAS voltage V_{BIAS} versus time is shown. In the course of time, the inkjet device operates in different modes. Unlike in FIG. 2A, in FIG. 2B, the BIAS voltage V_{BIAS} is a negative voltage, instead of a positive voltage. At t₀,the inkjet device is first in the first mode. In the first mode of the inkjet device no BIAS voltage V_{BIAS} is applied over the piezo-electric element. Because there is no BIAS voltage V_{BIAS} applied, there is no BIAS voltage V_{BIAS} over the piezo-electric element, as is shown in FIG. 2B.

The inkjet device is in the first mode until t₁. At t₁, a RAMP UP 50^{A} of the BIAS voltage V_{BIAS} is applied. As a consequence, at t₂, the BIAS voltage V_{BIAS} is at the level of the first BIAS voltage. The inkjet device is now in the second mode. The inkjet device stays in the second mode from t₂ to t₃. During this period, the first BIAS voltage V_{BIAS} is applied over the piezo-electric actuator. At t₃, a second RAMP UP 50^{B} of the BIAS voltage V_{BIAS} is applied, thereby increasing the BIAS voltage V_{BIAS} from the first BIAS voltage to the second BIAS voltage. The inkjet device is now in the third mode. The inkjet device stays in the third mode from t₄ to t₅. During this period, the second BIAS voltage V_{BIAS} is applied over the piezo-electric actuator. At t₅, a RAMP DOWN 51 of the BIAS voltage V_{BIAS} is applied, thereby decreasing the BIAS voltage V_{BIAS} from the second BIAS voltage 0. At t₆, the inkjet device is in the first mode again.

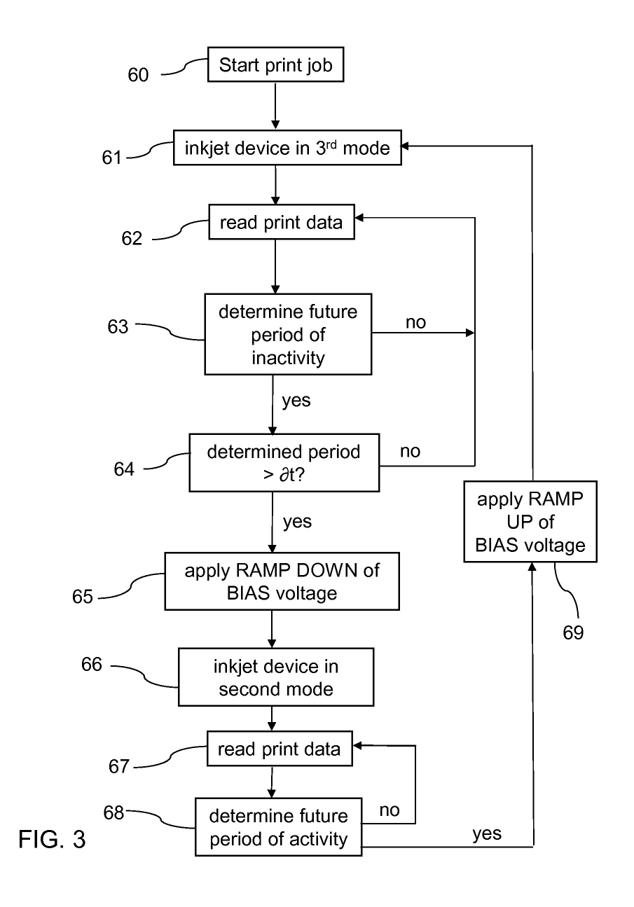

FIG. 3 shows a flow diagram of an embodiment of a method according to the present invention for operating an inkjet device 4 as performed by the control unit 10. At the start of a print job, as is indicated in step 60, the inkjet device 4 is switched in the third mode in a second step 61. Thus, the inkjet device 4 is in the operative state and the second BIAS voltage is applied to the piezo-electric element. In the operative state, the inkjet device 4 may expel droplets. The control unit 10 may control the expel of droplets by the inkjet device 4. Note that in an embodiment, another mode may be suitably selected.

For example, the method may start at step 66, which is elucidated below.

In a third step 62, the print data are read. The print data may be generated by the control unit 10 (also known as controller) based on image data. The image data may be received from an external source, e.g. the print data may be retrieved from a computer network or a USB stick. Based on the print data, the control unit 10 may control the inkjet device 4. Furthermore, in the fourth step 63, the control unit 10 determines whether there is a future period of inactivity. For example, a period of inactivity may be a period, wherein the inkjet device 4 does not eject any droplets, according to the print data. If there is no future period of inactivity, then print data are continued to be read, so the method returns to step 62 as long as there is print data to be read. As long as there is no period of inactivity detected, the control unit 10 continues to read print data and determine, based on these print data, whether there is a future period of inactivity, as is indicated in steps 62, 63. If there is a future period of inactivity detected in the fourth step 63, then the control unit 10 proceeds to step 64 and determines the length of the period of inactivity. In the fifth step 64, the determined period of inactivity is compared to a predetermined period of time. If the determined period of inactivity is not longer than the predetermined period of time, then the level of the BIAS voltage applied is not changed. The control unit 10 may continue to read the print data, as indicated in step 62 and, based thereon, determined a future period of inactivity, as indicated in step 63.

However, if the determined period of inactivity is longer than the predetermined period of time, then, in the sixth step 65, the control unit may apply a RAMP DOWN of the BIAS voltage at the start of the period of inactivity. By applying a RAMP DOWN of the BIAS voltage, in a seventh step 66, the BIAS voltage may be brought from the second BIAS voltage to the first BIAS voltage. By bringing the BIAS voltage from the second BIAS voltage to the first BIAS voltage, the inkjet device 4 is brought from the third mode in the second mode. When applying the first BIAS voltage to the piezo-electric element, the piezo-electric element may depolarize to some extend, compared to the third mode. However, the piezo-electric element may not fully depolarize. The predetermined period of time and the first BIAS voltage may be suitably selected, such that the piezo-electric element is sufficiently polarized to efficiently expel droplets when the inkjet device 4 returns to the active state.

After the inkjet device 4 has been brought in the second mode, wherein the inkjet device 4 is in a standby state, the control unit 10 may continue to read print data in an eight step 67. Based on these print data, the control unit 10 determines if there is a future period of activity, as indicated in the ninth step 68. A future period of activity may be a period wherein the inkjet device 4 does expel droplets, in accordance with the print data.

If there is no future period of activity detected, the control unit 10 continues to read the print data and based thereon, determine whether there is a future period of activity, as indicated in steps 67, 68. If, in step 68, the control unit detects a future period of activity, then the control unit 10 may apply a RAMP UP of the BIAS voltage in a tenth step 69, thereby bringing the inkjet device 4 in the third mode. When the inkjet device 4 is brought into the third mode, in step 61, then the control unit 10 may read print data in step 62 as is explained above.

In an embodiment, the control unit 10 may at a certain moment determine that the inkjet device is to be brought in an off state. For example, when there are no more image data received by the control unit 10, based on which the control unit can generate print data, then the control unit may switch off the BIAS voltage, thereby bringing the inkjet device 4 in the first state.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

1. Method for operating an inkjet device, said inkjet device comprising a piezoelectric actuator comprising a piezo-electric element, the method comprising a first mode, wherein the inkjet device is in an off state, a second mode, wherein the inkjet device is in a standby state and a third mode of the inkjet device, wherein the inkjet device is in an operative state, and wherein the method comprises the steps of:
a. in the first mode, applying no BIAS voltage over the piezo-electric element;
b. in the second mode, applying a first BIAS voltage over the piezo-electric element;
c. in the third mode, applying a second BIAS voltage over the piezo-electric element, wherein the second BIAS voltage is higher than the first BIAS voltage.

2. Method according to claim 1, wherein a ramp up of the BIAS voltage is applied to increase the BIAS voltage from the first BIAS voltage to the second BIAS voltage upon going from the second mode to the third mode.

3. Method according to claim 1, wherein a ramp down of the BIAS voltage is applied to decrease the BIAS voltage from the second BIAS voltage to the first BIAS voltage upon going from the third mode to the second mode.

4. Method according to claim 1, wherein the piezo-electric element has an upper surface and a bottom surface, the upper surface and the bottom surface each being provided with an electrode for actuating the piezo-electric element, wherein a distance between the upper surface of the piezo-electric element and the bottom surface of the piezo-electric element is in the range of 0.5 μm-15 μm.

5. Method according to claim 3, wherein the inkjet device is operatively coupled to a control unit, the control unit being adapted to receive image data to be printed, the control unit being further adapted to generate print data from the image data and to control the inkjet device to expel droplets in accordance with the print data by driving the piezoelectric actuators, wherein the method comprises the steps of:
1. in operation of the inkjet device, determining a future period of inactivity of the piezoelectric actuator based on the print data;
2. comparing the determined period of inactivity with a predetermined period of time (δt),
wherein, if the determined period of inactivity is larger than the predetermined period of time (δt), the method further comprises the step of:
3. at the start of the period of inactivity, applying the ramp down of the BIAS voltage to decrease the BIAS voltage from the second BIAS voltage to the first BIAS voltage thereby bringing the inkjet device in the second mode.

6. Method according to claim 1, wherein the inkjet device is configured for jetting droplets of an ink composition at an elevated temperature, wherein in the second and third mode, the piezo-electric actuator is controlled to be at the elevated temperature.

7. Method according to claim 6, wherein the ink composition is a hot melt composition, the hot melt composition being a composition that is solid at room temperature and liquid at an elevated temperature, wherein in the second and third mode, the piezo-electric actuator is controlled to be at the elevated temperature.

8. Method for operating a printing device, the printing device comprising a control unit, a first inkjet device and a second inkjet device, the control unit being configured to operate each of the inkjet devices in accordance with claim 1 independently.

9. Method according to claim 8, wherein the first inkjet device and the second inkjet device are integrated in one print head.

10. Method according to claim 9, wherein multiple print heads are integrated in one inkjet device.
